(19) United States
(12) Patent Application Publication
(10) Pub. No.: US 2014/0001346 A1
(43) Pub. Date: Jan. 2, 2014

(54) IMAGE PROJECTION DEVICE AND DETECTION METHOD THEREOF

(71) Applicant: LITE-ON IT CORPORATION, Taipei (TW)

(72) Inventors: Chun-Hung Chen, Hsinchu (TW); Kai-Wen Cheng, Hsinchu (TW)

(73) Assignee: LITE-ON IT CORPORATION, Taipei (TW)

(21) Appl. No.: 13/677,294

(22) Filed: Nov. 14, 2012

(30) Foreign Application Priority Data
Jun. 29, 2012 (CN) 201210220134.5

(51) Int. Cl. G01J 1/42

(52) U.S. Cl. CPC G01J 1/42
USPC 250/221

(57) ABSTRACT

A detection method of an image projection device is disclosed. A projection beam is projected on a plurality of projection regions within a projection range, wherein the projection beam carries different features when the projection beam is projected on different projection regions. A reflected beam from the projection range is received and converted to an electrical signal. The feature existing in the electrical signal is analyzed. The projection region corresponding to the feature is determined to identify which of the projection regions is/are blocked by an object.

This application claims the benefit of People's Republic of China application Serial No. 201210220134.5, filed Jun. 29, 2012, the subject matter of which is incorporated herein by reference.

### BACKGROUND

1. Technical Field

The disclosure relates in general to an image projection device, and more particularly to an image projection device with a function for detecting an object and a detection method thereof.

2. Description of the Related Art

The micro-projection device comprises a pocket projector and a pico projector, both adopting an optical-mechanical system and a backlight design applicable to small mechanism. Due to the advantage of “miniaturization”, the micro-projection device is highly portable, and may even be integrated with other mobile products (such as smart phone, digital camera, notebook computer). The mobile product, when integrating with a pico projector, may produce a larger projection range for the convenience of the user's viewing. In recent technologies, the pico projector can be a scan-type image projection device for its small mechanism.

The mobile product, when integrating with a pico projector, produces a larger projection range. If the user operates in the projection range (such as typing and dragging) and the mobile product detects and/or determines the user's operation, it would be much more convenient to the user.

In terms of the current technologies, the position of an object within a projection range may be detected by the following detection methods. (1) The image position is captured by an image capturing unit such as a charge-coupled device (CCD) and then the captured position is estimated through calculation. However, detection method (1) requires complicated circuits for performing complicated computation. (2) The swing position or angle of the reflecting mirror of the micro-electro-mechanical system (MEMS) is detected when a reflected light is received by the image projection device, and the scan position of the beam is estimated to obtain the position at which the object is located. However, detection method (2) requires extra circuits for detecting the swing position or angle of the reflecting mirror of the micro-electro-mechanical system, and more circuit costs are required.

### SUMMARY OF THE DISCLOSURE

The disclosure is directed to an image projection device, which adds a projection region related feature to a projection beam to determine the projection region blocked by an object and accordingly determine the projection region at which the object is located or the movement state of the object.

According to an embodiment of the present disclosure, a detection method of an image projection device is disclosed. A projection beam is projected on a projection range having a plurality of projection regions, the projection beam projecting on different projection regions having different features. A reflected beam reflected the projection range is received and converted to an electrical signal. The feature existing in the electrical signal is analyzed. The projection region corresponding to the feature is determined and it is determined which of the projection regions is/are blocked by an object.

According to another embodiment of the present disclosure, an image projection device is disclosed. The image projection device comprises a light source, a scan driving system, and a processing unit. The light source is used for projecting a projection beam on a projection range having a plurality of projection regions, the projection beam projecting on different projection regions having different features. The scan driving system is used for controlling a projection direction of the projection beam. The detector is used for receiving and converting a reflected beam reflected from the projection range to obtain an electrical signal. The processing unit is used for analyzing the feature existing in the electrical signal and determining the projection region corresponding to the feature, and determining which of the projection regions is/are blocked by an object.

According to still another embodiment of the present disclosure, a detection method of an image projection device is provided. A projection beam is projected on a projection range having at least a first projection region and a second projection region, the projection beam has a first feature when the projection beam is projected on the first projection region, and the projection beam has a second feature when the projection beam is projected on the second projection region. A reflected beam is converted to an electrical signal. The electrical signal is analyzed to obtain an analytic feature. The analytic feature is compared with the first feature and the second feature. If the analytic feature and the first feature are the same, then it is determined that the reflected beam is a reflected beam of the projection beam projected on the first projection region. If the analytic feature and the second feature are the same, then it is determined that the reflected beam is a reflected beam of the projection beam projected on the second projection region.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an image projection device;

FIG. 2A shows a plurality of regions with different features within a projection range according to an embodiment of the disclosure;

FIG. 2B and FIG. 2C show a movement state of an object and an electrical signal carrying corresponding feature according to an embodiment of the disclosure;

FIG. 3 shows a virtual keypad and a projection beam according to an embodiment of the disclosure;

FIG. 4 shows a projection beam projecting on a projection region according to an embodiment of the disclosure;

FIG. 5 shows an embodiment of a feature of a projection beam; and

FIG. 6A and FIG. 6B show the determination of a region blocked by an object by analyzing a feature of an electrical signal according to an embodiment of the disclosure.

### DETAILED DESCRIPTION OF THE DISCLOSURE

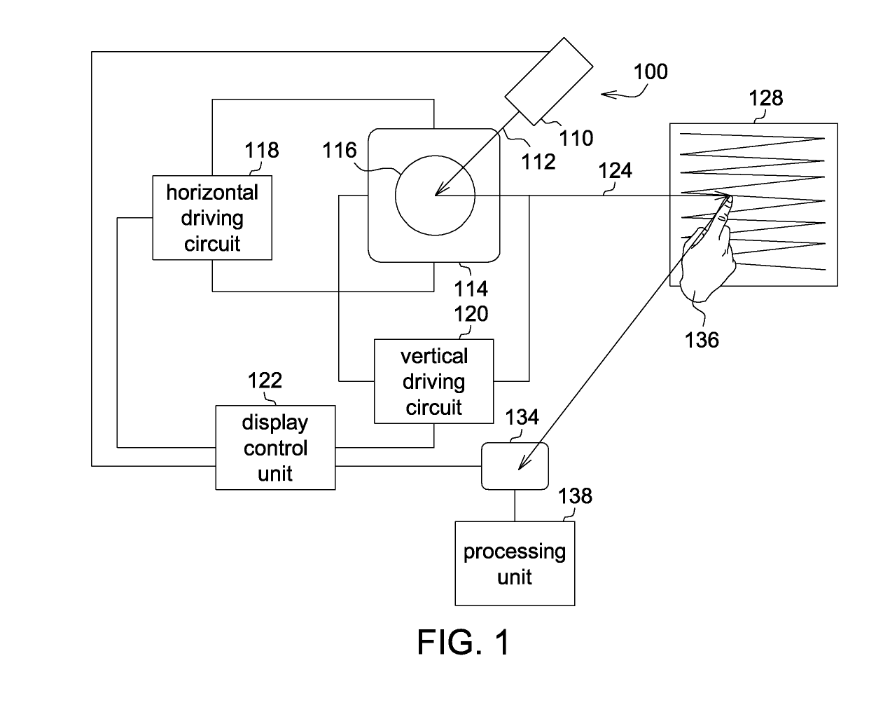

Referring to FIG. 1, a schematic diagram of an image projection device is shown. The image projection device 100 comprises a light source 110, a scan platform 114, a horizontal driving circuit 118, a vertical driving circuit 120, a display control unit 122, a detector 134 and a processing unit 138.

The projection beam 112 emitted by the light source 110 is projected on the scan platform 114. The scan platform 114 comprises a scan unit 116. The scan unit 116 is such as a micro-electro-mechanical scan unit. The projection beam 112 is reflected by the scan unit 116 into an output projection beam 124. The scan unit 116 controls the output projection beam 124 to scan the projection plane back and forth to form an image 128. The projection plane is such as a wall, a screen, and a paper or a cloth projection surface. The light source 110 may comprise one or multiple lasers. Alternatively, the light source 110 may comprise red, blue and green laser lights.

The horizontal driving circuit 118 and the vertical driving circuit 120 may modulate the swing direction of the scan unit 116 to adjust the projection angle and position of the output projection beam 124, so that the output projection beam 124 scans the projection plane back and forth to form the image 128.

The display control unit 122 may control the horizontal driving circuit 118 and the vertical driving circuit 120, and synchronize the scan platform 114, the horizontal driving circuit 118 and the vertical driving circuit 120 to form the image 128 by converting the pixel data of the image into laser light modulation information.

Alternatively, the scan platform 114, the horizontal driving circuit 118 and the vertical driving circuit 120 together are referred as a scan driving system.

The detector 134 detects the beam reflected by the object 136. The processing unit 138 analyzes the detection result of the detector 134 and identifies which region(s) within the projection range is blocked and further identifies the region at which the object is located or the movement state of the object.

In an embodiment of the disclosure, the image projection device projects a virtual keypad image for the user to operate with, and the user may type with the virtual keypad image. In an embodiment of the disclosure, the region at which the object is located or the movement state of the object is determined according to the reflected beam generated when the projection path of the projection beam (visible light or invisible light) is blocked by an object (such as the user's finger).

In an embodiment of the disclosure, a special label (referred as a ‘feature’ here below) related to the projection region of the projection beam is added to the projection beam. After the beam reflected by the object is converted into an electrical signal, the feature existing in the electrical signal still may be detected. The projection region at which the object (the finger) is located may be determined according to the feature existing in the electrical signal and the corresponding projection region.

Thus, the change in the feature of the electrical signal represents the change in the projection region at which the object is located, so that the proceeding path of the movement of the object is estimated and the user's operation is understood. In an embodiment of the disclosure, the projection region at which the object is located and the change in the said projection region is detected. As for how to determine the user's operation according to the region detection result is the subsequent applications of the present embodiment of the disclosure, and the details of determining the user's operation are not subjected to specific restrictions.

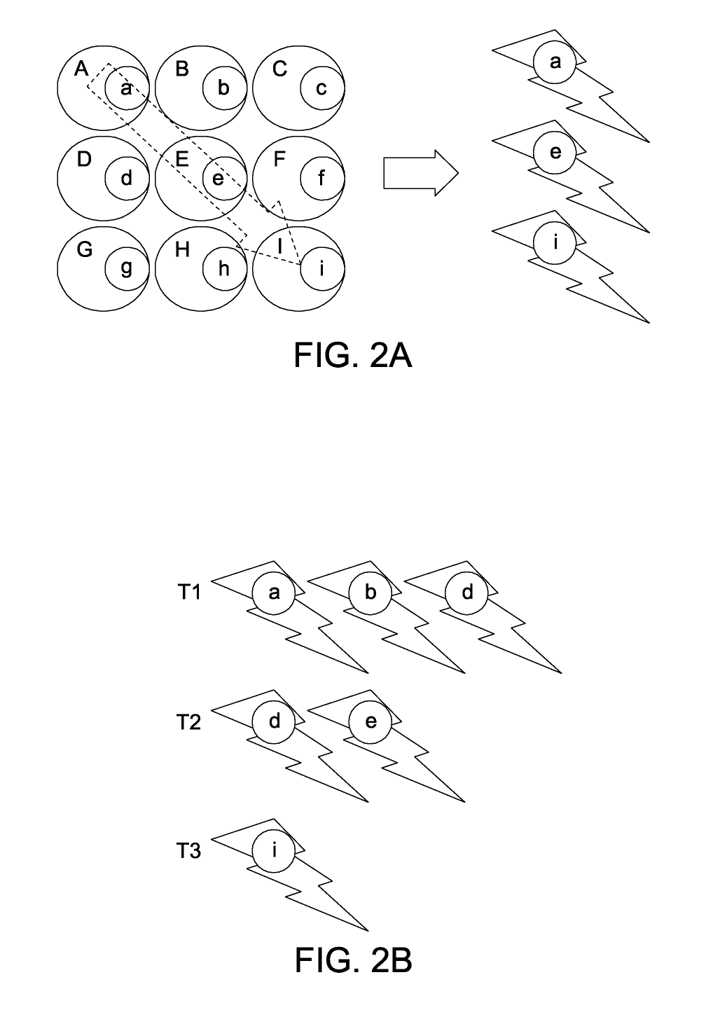

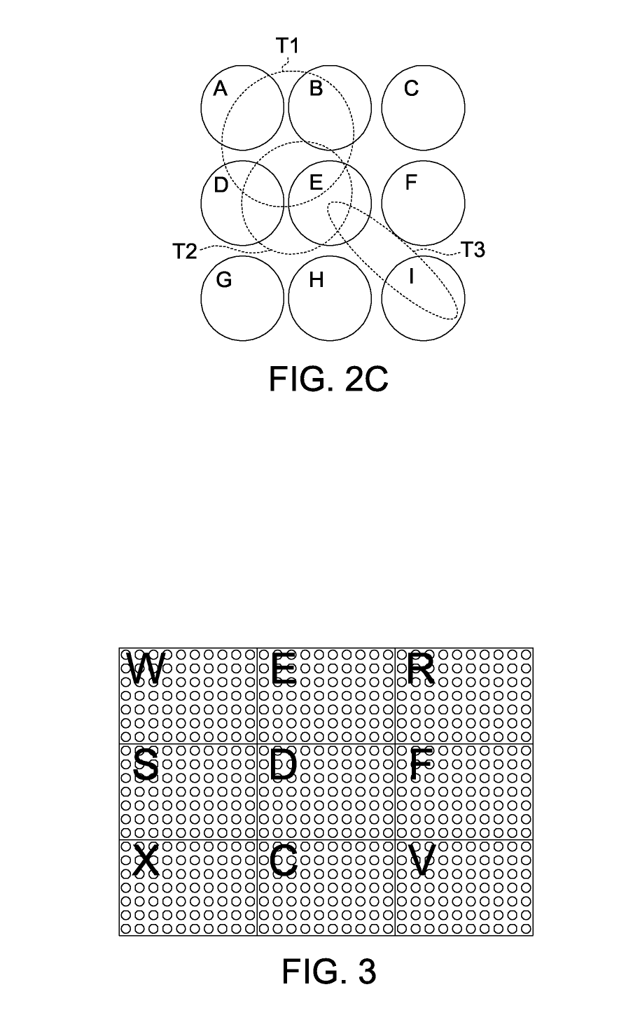

Referring to FIG. 2A, a plurality of regions within a projection range according to an embodiment of the disclosure is shown. Suppose there are 9 regions A˜I within the projection range. When the projection beam 112 emitted by the light source 110 is projected on the 9 regions A˜I, the projection beam 112 projected into the regions carries features a˜i respectively. That is, when the projection beam 112 is projected on region A, the beam 112 carries feature a, and so on. The embodiments of the features a˜i are disclosed below with accompanying drawings.

Suppose in the movement path, the object passes through regions A→E→I in order, the image projection device will receive a beam reflected by the object at region A, region E and region I respectively. As indicated in FIG. 2A, after the reflected beam reflected from the region A is converted by the detector 134, the converted electrical signal carries feature a. After the reflected beam reflected from the region E is converted by the detector 134, the converted electrical signal carries feature e. After the reflected beam reflected from the region I is converted by the detector 134, the converted electrical signal carries feature i. The processing unit 138 analyzes the features in the electrical signal, and accordingly determines the regions at which the object is located according to the features, and determines the movement state of the object according to the sequence of the features. For example, when the processing unit 138 analyzes and determines that the feature existing in the electrical signal is feature a, this indicates that the object is located at region A of the projection range. Then, when the processing unit 138 analyzes and determines that the feature existing in the electrical signal is feature e, this indicates that the object is located at region E of the projection range. That is, the object moves to region E from region A.

In the present embodiment, the movement state of the object may be determined by analyzing the electrical signals carrying the features and the appearing order and change of the feature.

The above embodiment is exemplified by the situation that the object blocks one single region. In other embodiment, the object may block many regions at the same time. In the present embodiment, the image projection device may convert the reflected beam into the electrical signal, analyze the features existing in the electrical signal, and accordingly determine which regions are blocked by the object according to the features. Then, the movement state of the object is determined according to the timing and detection of the blocked region by the object.

Referring to FIG. 2B and FIG. 2C, a movement state of an object and electrical signal carrying corresponding features according to an embodiment of the disclosure are shown. At time point T1, if it is detected that the electrical signal carries features a, b and d, then it is determined that the object blocks regions A, B and D at time point T1. That is, at time point T1, it is determined that the object moves into regions A, B, and D as indicated in FIG. 2C. Likewise, at time point T2, if it is detected that the electrical signal carries features d and e, then it is determined that the object blocks regions D and E at time point T2. That is, at time point T2, it is determined that the object moves into regions D and E as indicated in FIG. 2C. At time point T3, if it is detected that the electrical signal carries features i, then it can be determined that the object blocks region I at time point T3. That is, at time point T3, it is determined that the object moves to the region I as indicated in FIG. 2C.

In an embodiment of the disclosure, detection of blocked region by the object may be obtained according to the electrical signal carrying feature and its appearing order, and the movement of the object can be identified accordingly.

In the present specification of the disclosure, ‘resolution’ refers to the number of beams within the projection range, and one beam refers to one pixel. For example, the resolution of 1280*720 denotes that 1280 beams are projected in the horizontal direction, 720 beams are projected in the vertical direction, and 1280*720=921600 beams are projected in total. However, the disclosure is not limited to the above exemplification.

In an embodiment of the disclosure, different patterns may be projected under different applications. The projected pattern may be divided into multiple regions (the sizes of the regions do not have to be the same). Different features are assigned to the projection beams projected at different regions, so that the features may represent the positions of the regions. That is, if it is detected that the electrical signal carries one of the features, then which region(s) is/are blocked by the object may be determined according to the features.

In an embodiment of the disclosure, for the convenience of the user's manual typing, the image projection device may such as project a virtual keypad image. However, the disclosure is not limited to such exemplification, and the image projection device may project other pattern for accepting and detecting the user's operation, and such exemplification is still within the scope of the embodiment of the disclosure.

The image projection device projects three RGB beams at specific position and timing on the scan path to form a projection beam. When an obstacle (such as an object or a finger) enters the projection range, the projection beam will be reflected by the obstacle into a reflected beam accordingly.

In an embodiment of the disclosure, adding different features to projection beams which scan different regions is referred as signal modulation. Even after the reflected beam having the added feature is converted to an electrical signal by a photo sensor, the feature still is found in the electrical signal. Based on the feature of the electrical signal, it may be determined that the electrical signal is obtained by converting the beam reflected at which region, and the reflected beam is from the region blocked by a finger or an object. That is, in an embodiment of the disclosure, the movement state of the finger or the object within the scan range of the projection beam can be observed according to the feature of the electrical signal.

FIG. 3 shows a virtual keypad and a projection beam for forming the virtual keypad according to an embodiment of the disclosure. As indicated in FIG. 3, the virtual keypad at least comprises regions W, E, R, S, D, F, X, C and V, wherein each region comprises a plurality of projection beams. It is noted that FIG. 3 shows a portion of the virtual keypad, but the disclosure is not limited thereto, and, the number of beams within a region is not limited to the exemplification in FIG. 3.

In an embodiment of the disclosure, a known feature is added to the projection beam by changing a parameter of driving signals for driving the projection beam. The feature, such as frequency, waveform and phase, varies with the position of the projection region, such that the projection beam carries a feature when the projection beam is projected on a projection region. In an embodiment of the disclosure, the parameter such as frequency, waveform and phase or any combination thereof may be used as a feature as long as such feature still exists when converting the reflected beam to the electrical signal. Thus, which region is blocked by the object is estimated or identified.

In an embodiment of the disclosure, the ON/OFF switching frequency variation is used as a feature added to the projection beam. That is, the projection beam projected on different regions has different ON/OFF switching frequencies. After the reflected beam having the ON/OFF switching frequency is converted into the electrical signal by the detector, the feature of the ON/OFF switching frequency still exists in the electrical signal. Relatively, amplitude of the projecting beam may change after converting the reflected beam detected by the detector to the electrical signal and thus the amplitude parameter is not suitable to be used as a feature in the embodiment of the disclosure.

In an alternate embodiment of the disclosure, the phase parameter may be used as a feature added to the projection beam. That is, if the projection beams projected on different regions have different phase differences, after the reflected beams having the different phase differences are converted into the electrical signals by the detector, the feature of the phase difference still exists in the electrical signals. Therefore, the movement state of an object may be obtained by analyzing the phase differences contained in the electrical signals.

For example, let the phase difference of a projection beam projected on the first region be 90 degrees and the phase difference of a projection beam projected on the second region be 0 degree. After converting the reflected beam into the electrical signal, if the phase difference contained in the electrical signal is 90 degrees, then it is determined that the electrical signal is converted from the reflected beam that is reflected from the projection beam projected on the first region. Likewise, if the phase difference contained in the electrical signal is 0 degree, then it is determined that the electrical signal is converted from the reflected beam that is reflected from the projection beam projected on the second region.

In another embodiment of the disclosure, the waveform parameter may used as a feature added to the projection beam. That is, the projection beam projected on different regions has different waveforms. After the reflected beams are converted into the electrical signals, the electrical signals converted from different reflected beams reflected from different regions still have different waveforms. Therefore, the movement state of an object may be estimated through the analysis of the waveform contained in the electrical signal.

For example, the projection beam projected on the first region is a triangular wave, and the projection beam projected on the second region is a sine wave. After converting the reflected beam into the electrical beam, if the waveform of the electrical signal is a triangular wave, then it is determined that the electrical signal is converted from the reflected beam that is reflected from the projection beam projected on the first region. Likewise, if the waveform of the electrical signal is still a sine wave, then it is determined that the electrical signal is converted from the reflected beam that is reflected from the projection beam projected on the second region.

For the projection beams projected on the same region, there may be one or more than one projection beams carrying feature according to the needs and hardware specifications. To put it in greater details, more projection beams carrying feature, higher determination accuracy.

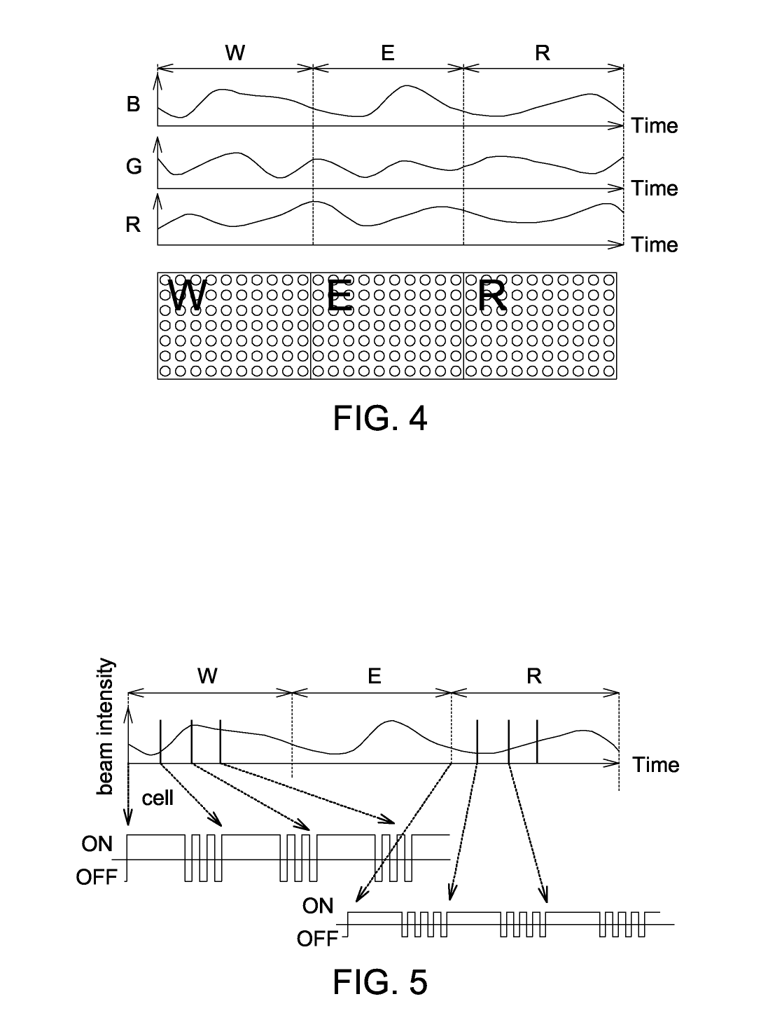

Referring to FIG. 4, an embodiment of the disclosure is exemplified by regions W, E and R which are projected by beams having features. The projection beam has three RGB beams. The vertical axis denotes the intensity of the RGB beams, and the horizontal axis denotes the projection timing. Based on different requirements, a region may be divided into one or multiple cells, and one or more beams projected on the cells in the same region have the same ON/OFF switching frequency. A cell may be projected by one or more projection beams according to the needs and hardware specifications. That is, for the projection beams projected on the same region, if the projection beams carry features, the features are the same.

FIG. 5 shows features added to projection beams according an embodiment of the disclosure. As indicated in FIG. 5, the projection beam projected on cells within the region W has 3 ON/OFF switching pulses (that is, the feature of the projection beam is 3 ON/OFF switching pulses). Likewise, the projection beams projected on cells within the region R have 4 ON/OFF switching pulses.

Since the feature of the electrical signal is related to the feature added to the projection beam, as disclosed above, the projection beam projected at different regions has different features. That is, the added feature is related to the region and/or the position. Through the analysis of the feature contained in the electrical signal, it is identified that which region(s) is/are blocked by the object movement or tapping, and which virtual key of the virtual keypad is tapped is identified through subsequent processing.

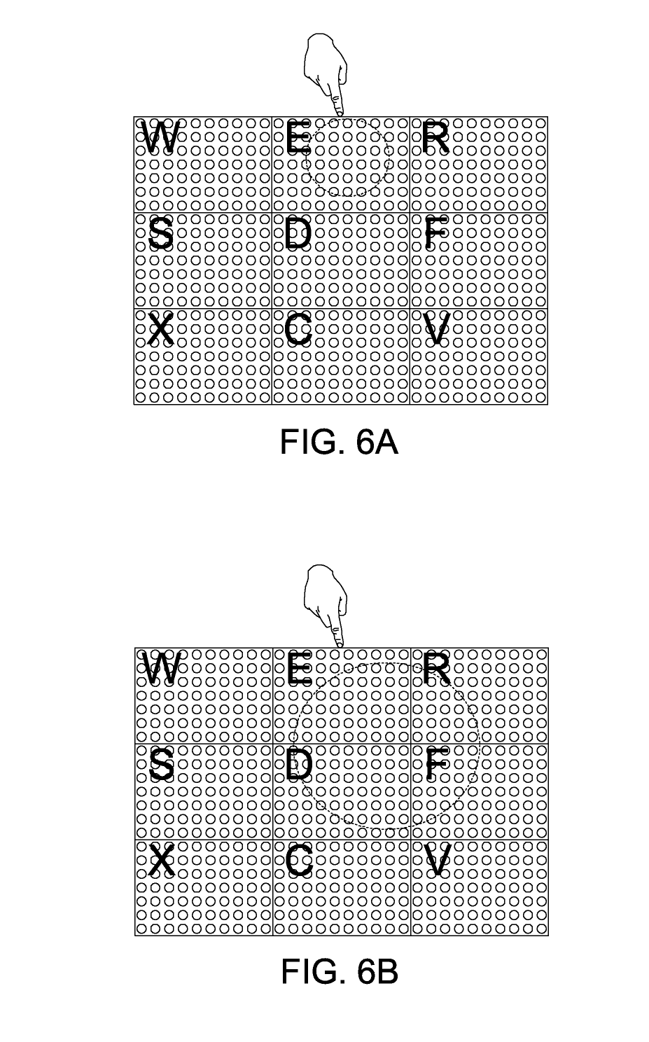

As indicated in FIG. 6A, if the analysis of the electrical signal shows that the feature of the electrical signal is related to region E (virtual key E), then it is determined that the region E is blocked due to the finger's action. As indicated in FIG. 6B, if the analysis of the electrical signal shows that the feature of the electrical signal is related to regions E, R, D and F (virtual keys E, R, D and F), then it is determined that the regions E, R, D and F are blocked due to the finger's action.

In practice, keypad input is often done by way of tapping, and the change in blocked region is complicated. The analysis of blocked region may be used to identify which keys are tapped by the user and the tapping order. The above identification may be achieved by suitable algorithm and is not restricted in the present embodiment of the disclosure.

In another embodiment of the disclosure, a virtual chessboard is projected. The projection device projects a chessboard and chessmen, and the feature added to the projection beam projected on grid boundary is according to the position of grid boundary. Finger movement causes in the regions to be blocked and is represented in the feature existing in the electrical signal. Through the analysis of the features of the electrical signal, it is determined that the finger moves a chessman (such as two grids rightward), and the frame is updated to complete the current step of the chess game.

According to the above embodiments of the disclosure, the image projection device may project a related pattern, and the user may input or typing with respect to the projected pattern. In the above exemplification, the image projection device and the mobile phone are combined, and the image projection device projects a virtual keypad image for the convenience of the user's typing input. The physical but small keypad of the mobile phone or the small virtual keypad displayed on the mobile phone is inconvenient for the user to input or typing. According to the above embodiments of the disclosure, the user may manually type on the projected virtual keypad when user operates the mobile end terminal, hence resolving the problem encountered by the mobile phone whose physical size is not big enough.

According to the above embodiments of the disclosure, which region(s) is blocked by an object may be detected without complicated algorithms or extra circuits, the projection region blocked by the object or the movement state of the object may be estimated or detected accordingly.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A detection method of an image projection device, comprising:
projecting a projection beam on a projection range having a plurality of projection regions, the projection beam projecting on different projection regions having different features;
receiving and converting a reflected beam reflected from the projection range to obtain an electrical signal;
analyzing the feature existing in the electrical signal; and
determining which of the projection regions is/are blocked by an object.

2. The detection method according to claim 1, wherein, the feature is a feature of waveform, and the projection beam projecting on different projection regions has different waveforms.

3. The detection method according to claim 1, wherein, the feature is a feature of frequency, and the projection beam projecting on different projection regions has different frequencies.

4. The detection method according to claim 1, wherein, the feature is a feature of phase, and the projection beam projecting on different projection regions has different phases.

5. The detection method according to claim 1, wherein, the image projection device receives a plurality of reflected beams, analyzes the features existing in the corresponding electrical signals, and determines movement of the object according to an appearing order of the features.

6. An image projection device, comprising:
a light source used for projecting a projection beam on a projection range having a plurality of projection regions, the projection beam projecting on different projection regions having different features;
a scan driving system used for controlling a projection direction of the projection beam;
a detector used for receiving and converting a reflected beam reflected from the projection range to obtain an electrical signal; and
a processing unit used for analyzing the feature existing in the electrical signal and determining which of the projection regions is/are blocked by an object.

7. The image projection device according to claim 6, wherein, the feature is a feature of waveform, and the projection beam projecting on different projection regions has different waveforms.

8. The image projection device according to claim 6, wherein, the feature is a feature of frequency, and the projection beam projecting on different projection regions has different frequencies.

9. The image projection device according to claim 6, wherein, the feature is a feature of phase, and the projection beam projecting on different projection regions has different phases.

10. A detection method of an image projection device, comprising:
projecting a projection beam on a projection range having at least a first projection region and a second projection region, the projection beam has a first feature when the projection beam is projected on the first projection region, and the projection beam has a second feature when the projection beam is projected on the second projection region;
receiving and converting a reflected beam to obtain an electrical signal;
analyzing the electrical signal to obtain at least an analytic feature; and
wherein, if the analytic feature contains the first feature, then it is determined that the first projection region is blocked by an object,
wherein, if the analytic feature contains the second feature, then it is determined that the second projection region is blocked by the object.

11. The detection method according to claim 10, wherein, the feature is a feature of waveform, the first feature is a first waveform and the second feature is a second waveform, wherein the first waveform is different from the second waveform.

12. The detection method according to claim 10, wherein, the feature is a feature of frequency, the first feature is a first frequency and the second feature is a second frequency, wherein the first frequency is different from the second frequency.

13. The detection method according to claim 10, wherein, the feature is a feature of phase, the first feature is a first phase and the second phase is a second phase, wherein the first phase is different from the second phase.
